(19) United States
(12) Patent Application Publication
(10) Pub. No.: US 2026/0051722 A1
(43) Pub. Date: Feb. 19, 2026

(54) WIRES-HOLDING STRAP FOR BUILDING ELECTRICAL PANEL, APPARATUS AND METHOD

(71) Applicant: JASON W NOBLE, BOISE, ID (US)

(72) Inventor: JASON W NOBLE, BOISE, ID (US)

(21) Appl. No.: 19/297,771

(22) Filed: Aug. 12, 2025

Related U.S. Application Data
(60) Provisional application No. 63/682,697, filed on Aug. 13, 2024.

(51) Int. Cl. H02G 3/04; H02G 3/00; H02G 3/08

(52) U.S. Cl. CPC H02G 3/0456; H02G 3/08; H02G 3/263

(57) ABSTRACT

A panel-strap for securing electrical wires close to a building inside wall and close to an electrical junction box for building construction. During installation, the panel-strap is secured horizontally between vertical studs, or alternatively more directly to the building inside wall, but with a gap maintained between the back face of the panel-strap and the front face of the building interior wall. This way, the gap may be utilized by an electrician when future remodel or expansion of the building requires additional or substitute electrical lines to or from the junction box. The electrician may efficiently employ a “fish-stick” to secure and lead the new or substitute line past the panel-strap through the gap along the inside wall of the building for convenient delivery of the line to the proximity of the junction box and panel-strap for connecting thereto.

### BACKGROUND OF THE DISCLOSED TECHNOLOGY

### Field of the Disclosed Technology

This invention relates generally to building construction, preferably residential home construction. This invention may relate to building construction more broadly, including commercial construction, if the technology becomes widely accepted. More specifically, this invention relates to a strap between studs of a home or apartment wall for securing electrical wires close to electrical boxes or panels installed during construction of a residence.

In particular, the wires-holding strap of this invention provides for more convenient and efficient installation of additional or different wires later in the life of the residence during its expansion and/or remodeling.

### Related Art

Many residential communities have building codes which require that electrical lines or wires be secured within a short distance from the relevant electrical panel or junction box. Often, the required distance between the panel/box and the wire's point of securement is about 12 inches. These wires are typically secured to a horizontal wires-holding strap, which itself is secured between vertical studs for the interior wall of the building. The wires pass into, or out from, the panel/box, and are secured through holes, clamps or clips at the nearby “panel-strap” before extending further to outlets, electrical equipment and fixtures around the house.

Often, a wires-holding strap for electrical panels, or “panel-strap” as it is commonly referred to, is put together haphazardly from scrap lumbar by an electrician at the construction site. Also, the strap's holes, clamps or clips to secure the wires are fashioned on-site from whatever surplus, non-specialized materials, and with whatever non-specialized tools, may be available. For example, the electrician may cut a piece of left-over rough lumber, nail it between wall studs, and secure wires to this prior art panel-strap using conventional staples. (See FIGS. 5-7).

This is common practice because the installed “panel-strap” typically becomes covered with drywall and then interior wall coverings after installation, and hidden from sight. Therefore, very little attention is typically paid by the constructors to the quality of materials or care in construction methods, or resulting aesthetics, for the prior art “panel-strap”.

As a result, for better long-term construction practices, there is a current need for a more consistent, more effective “panel-strap” for electrical panels/boxes in residence construction, especially when factoring in reasonable planning for commonly encountered expansion and/or remodeling of the residence. This invention addresses that need.

Some existing building electrical wire-holding products are:
1. Stud-mounted cable supports, e.g. by Orbit Industries, Inc., including its CS-CJ6 Part No.,
2. Wall Stud Conduit and Cable Clips, e.g. by Grainger, CS812D Part No.,
3. Non-metallic Cable Standoffs, e.g. by Arlington Industries, CS4 Catalog Code; and,
4. Cable Chase Wire Brackets, e.g. by Rack-A-Tiers, CC 9024 Part No.

### SUMMARY OF THE DISCLOSED TECHNOLOGY

A technology disclosed herein is an elongate electrical “panel-strap”, preferably for residence construction. In one embodiment, the panel-strap is made of molded plastic material which may be conveniently fastened horizontally between two vertical studs of an inside building wall. The elongate panel-strap has a plurality of prongs which extend out and create slots in its front face towards the inside of the room when installed, the prongs being of plastic material extending outwardly, away from the panel-strap's front face and the inside residence wall when installed. The slots are adapted to receive and secure between themselves electrical lines extending out from or into the top of a nearby electrical panel or box typically beneath the “panel-strap” and between the wall studs. (See FIGS. 1, 8 and 9.) The panel-strap may be manufactured to be available in a first version which is secured between adjacent wall studs' inside surfaces. Also, the panel strap may be available in a second version which is secured to a building inside wall.

Another technology disclosed herein is a method of installing the panel-strap of FIGS. 1, 8 and 9. In order to be best effective for conveniently accommodating remodel or expansion of the building, when additional or substitute electrical lines are likely to be introduced to the panel/box, it is important that the “panel-strap” be installed between the relevant studs with a gap of at least about ½ inch, to about 2 inches and more, between the residence inside wall and the panel-strap's back face. This way, when a new or substitute electrical line is to be introduced to the panel/box, it may be more conveniently secured at its front end to a conventional electrician's “fish-stick” back end, pictured, for example, in FIGS. 1-4, and led in to close vicinity of the panel strap, with minimum disruption of the drywall and interior wall coverings over-laying the inside building wall, including the space between the studs supporting the panel-strap. Also, this way, the new or substitute electrical line may be installed into the panel/box, and secured to the panel-strap, with minimal time and effort, as well as minimal disruption to the panel-strap, its securing studs, and the nearby already overlaid drywall and interior wall coverings.

Another technology disclosed herein is a method of conveniently and effectively using the panel-strap as described above during later expansion and/or remodel of the residence to add additional electrical lines or to replace existing electrical lines coming out from, or going into, the electrical panel or box. For example, as depicted in FIGS. 1-4, an additional line's front end is secured to a conventional electrician's “fish-stick” back end, and the line introduced to close proximity of the panel-strap by pushing the “fish-stick's” front end through a gap between the back face of the panel-strap and the front of the building's inside wall. Then the “fish-stick” is pushed and/or pulled by the electrician manually further down and out through an opening under the drywall and interior wall coverings, leaving the new or substitute line's front end near the panel/box for installation therein. Upon disconnection of the line's front end from the “fish-stick”, the line may be conveniently connected into the nearby panel/box, as well as secured to the nearby panel-strap above, if desired. (In some building code jurisdictions, it is not required to secure additional/substitute wires “fish-sticked” into or through finished walls to a panel-strap.)

### BRIEF DESCRIPTION OF THE DRAWINGS

FIG. 1 is a schematic, front right-side perspective view of a section of an interior building wall and partial roof showing electrical wires in the wall secured by a panel-strap above an electrical panel box, and an electrician's “fish-stick” leading an additional wire inside the wall, according to embodiments of the present invention.

FIG. 2 is a schematic, front left-side perspective view of the embodiment of FIG. 1, but without the partial roof.

FIG. 3 is a front view of the embodiment of FIG. 2.

FIG. 4 is a right-side sectional view of the embodiment of FIG. 3 along the section line FIG. 4-FIG. 4 thereof.

FIG. 5 is a front left-side perspective view similar to FIG. 2, but with a prior-art panel-strap instead of one according to an embodiment of the present invention, the prior-art panel-strap being fashioned from scrap lumber and using conventional staples to secure wires to the panel strap.

FIG. 6 and FIG. 7 are front and right-side sectional views, respectively, of the prior art panel-strap depicted in FIG. 5.

FIG. 8 is a top, right-front perspective view of one embodiment of a panel-strap according to the present invention.

FIG. 9 is a top, left-back perspective view of the embodiment depicted in FIG. 8.

FIG. 10 is a top, right-front perspective view of an alternate fastened-to-wall embodiment of a panel-strap according to the present invention.

FIG. 11 is a top, left-back perspective view of the alternate panel-strap embodiment depicted in FIG. 10.

FIG. 12 is a top view of the alternate panel-strap embodiment depicted in FIGS. 10 and 11.

FIG. 13 is a back view of the alternate panel-strap embodiment depicted in FIGS. 10-13.

### DETAILED DESCRIPTION OF EMBODIMENTS OF THE DISCLOSED TECHNOLOGY

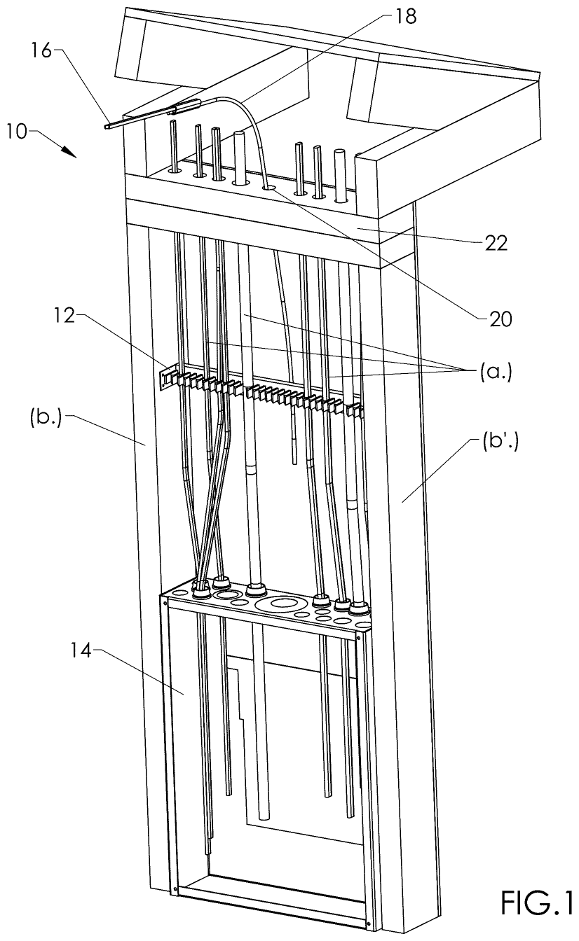

Referring to the Figures, there is depicted schematically in FIG. 1 a portion of an interior building wall and partial roof 10. Numerous different electrical wires (a.) are in the wall, secured to panel-strap 12, and entering into or coming out from electrical panel/box 14. Both panel-strap 12, and panel/box 14 are typically secured between studs (b.) on the left side, and (b′.) on the right side, when looking toward the wall from inside a room in the building.

Also depicted schematically in FIG. 1 is the front end of an additional wire 16 connected to the back end of a conventional electrician's “fish-stick” 18. When an additional wire 16 or a substitute wire (not specifically shown here) is meant to be introduced to panel/box 14 and secured to panel-strap 12, it is first secured to the back end of fish-stick 18, and manually moved by the electrician to come into close proximity to panel/box 14, for example, by first pushing the fish-stick 18 through a bore-hole 20 in header 22 near the top of studs (b.) and (b′.). Then additional wire 16 may be inserted and connected as desired into panel/box 14 and also secured into panel-strap 12. Exemplary electrician's “fish sticks” include Click‘N’Fish models available from rack-a-tiers.com/product.

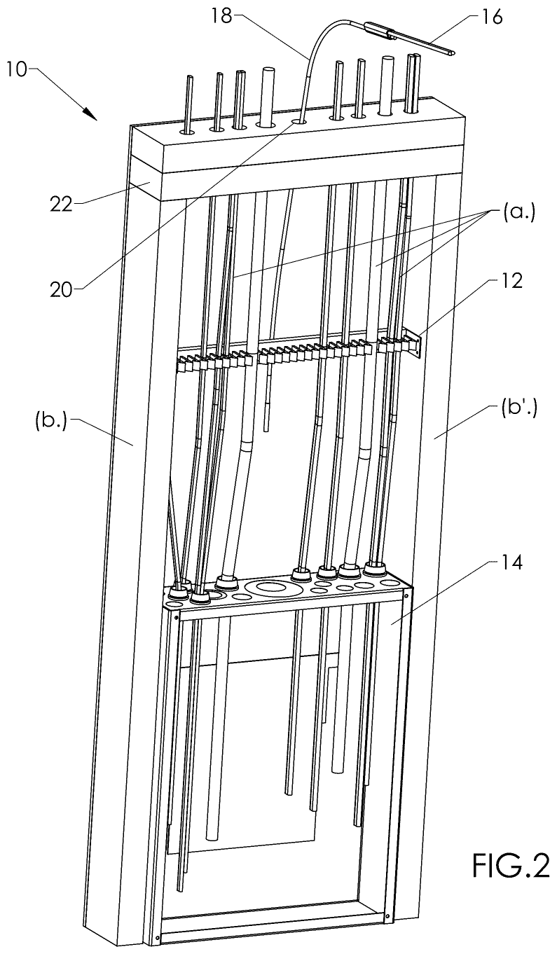

FIG. 2 is a view like FIG. 1, but from a different perspective and without the partial roof for simplicity. Wires (a.), and studs (b.) and (b′.), as well as panel-strap 12, panel/box 14, additional wire 16, electrician's fish-stick 18, bore-hole 20 and header 22 herein are the same as in FIG. 1.

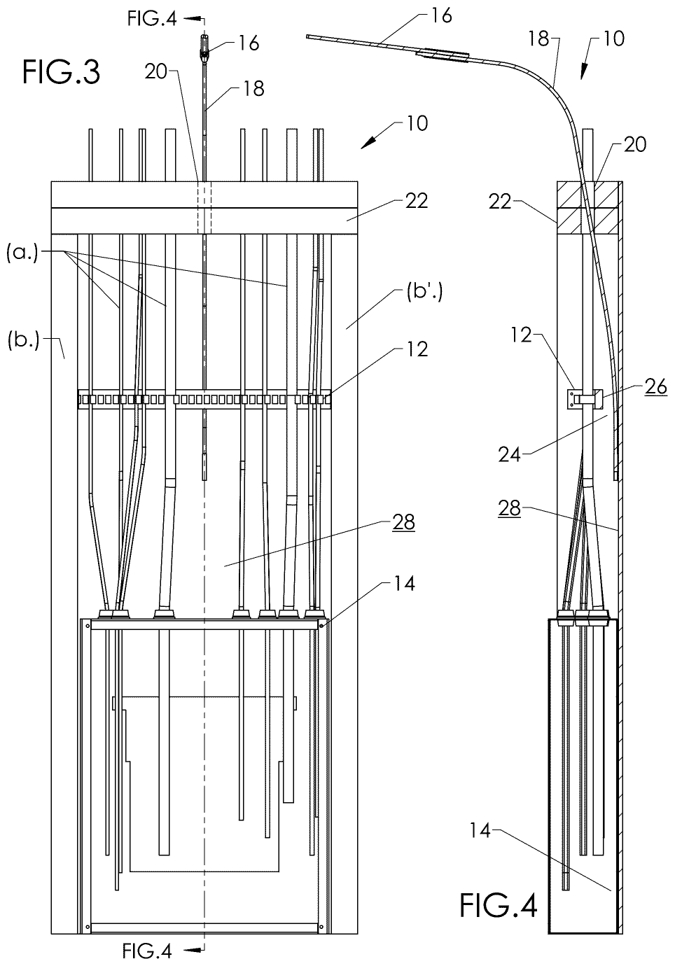

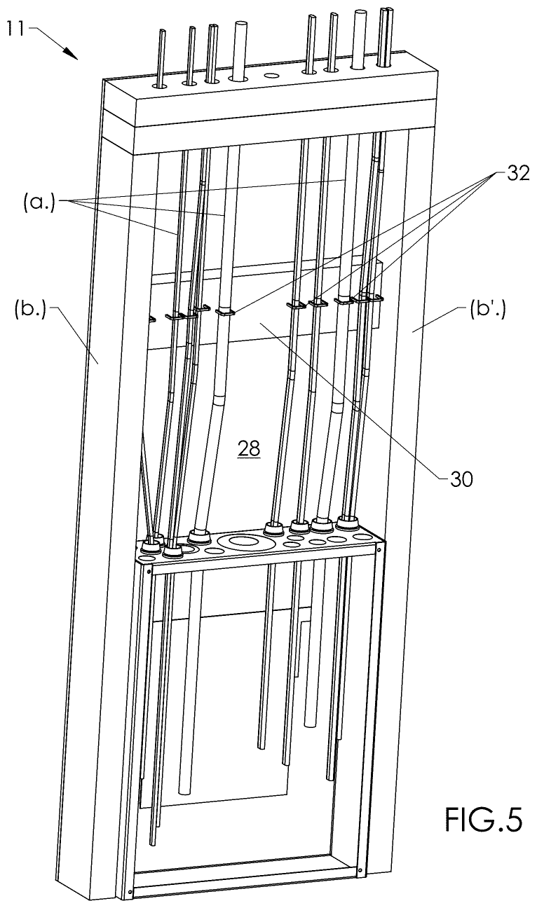

FIGS. 3 and 4 are similar to FIG. 2, except from different perspectives, and the right-side sectional view of FIG. 4 also shows a gap 24 between the back face 26 of the panel-strap 12 and the front of the building's inside wall surface 28. Here, one may clearly see the front end of fish-stick 18 with additional wire 16 secured to its back end passing downwardly through bore-hole 20 in header 22, and through gap 24 and back against the building's inside wall surface 28. This way, the electrician can manually push and/or pull fish-stick 18 and additional wire 16 into close proximity with panel/box 14 for introduction therein, as well as securement to panel-strap 12.

FIG. 5 is similar to FIG. 3, but from a different perspective, with a different interior building wall 11, and with a prior art panel-strap 30 instead of one according to the present invention. Prior art panel-strap 30 is fastened horizontally between studs (b.) and (b′.) above panel/box 14, the similar location as for panel-strap 12 according to the present invention. The various wires (a.) in FIG. 5 are secured to prior art panel-strap 30 with conventional staples 32, for example, instead of being secured between the prongs of panel-strap 12 according to the present invention as depicted in FIGS. 1-4.

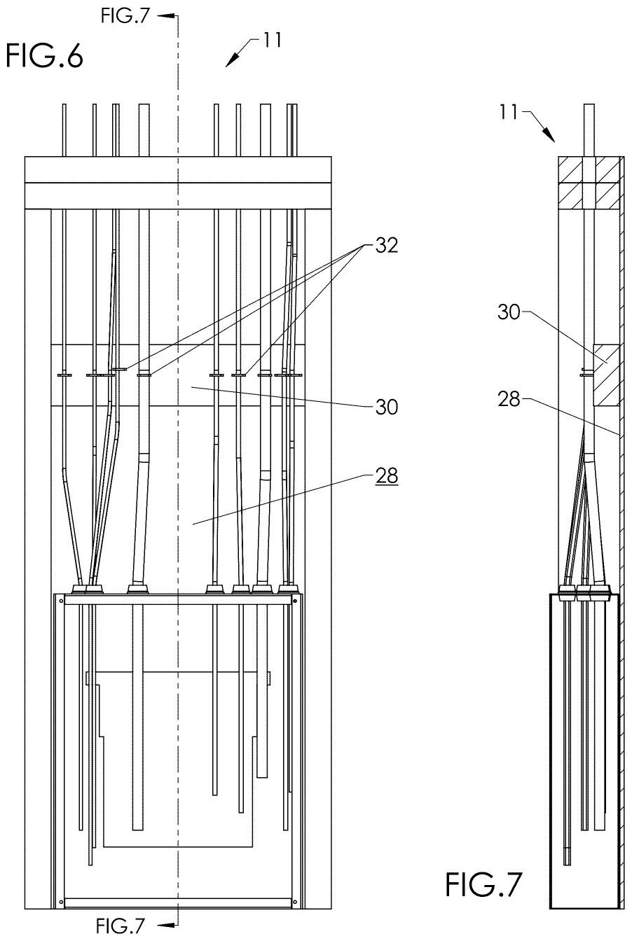

FIGS. 6 and 7 are front and right-front sectional views, respectively, of the different interior building wall 11, and the prior art panel-strap depicted in FIG. 5. FIG. 7 shows no gap space between the building inner wall surface 28 and the back face of the prior art panel-strap 30, which is flush to the building inner wall surface 28, and typical for known prior art panel-strap construction. This way, without the gap, there is no space behind the prior art panel-strap 30 and in front of the building inner wall surface 28 to practice the panel-strap installation method according to the present invention.

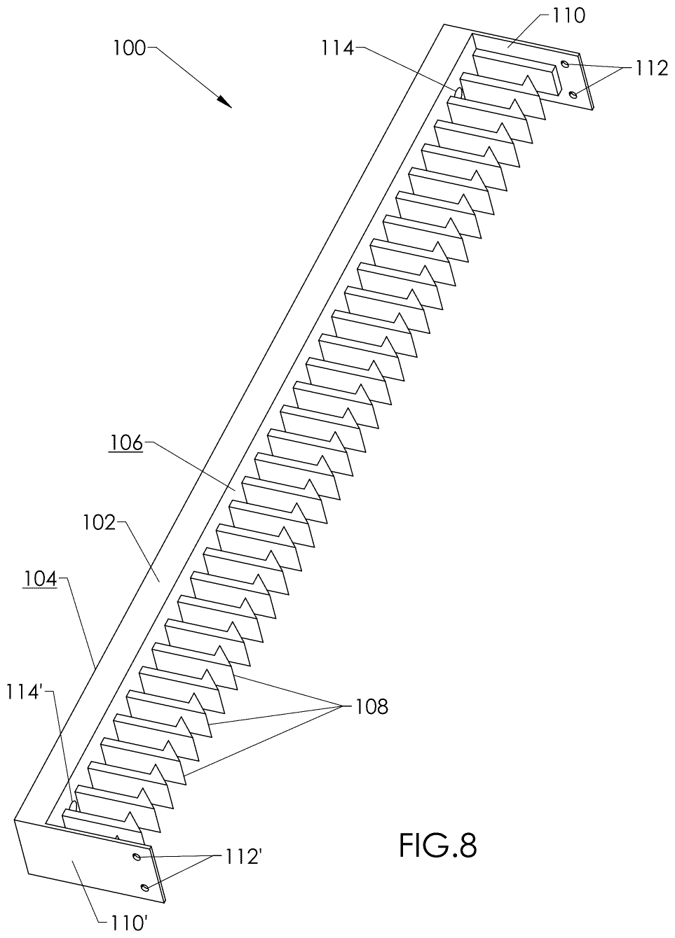

FIG. 8 is a top, right-front perspective view of one embodiment of a panel-strap 100 according to the present invention. FIG. 8 presents elongate panel-strap 100 with a generally rectangular base 102 extending the length of the panel-strap. Generally, panel-strap 100 is sized to fit comfortably between adjacent 2″×4″ (nominal) wall studs for residential construction on about 16″ centers. This results in a length of about 14″ for a typical panel-strap 100 of one embodiment of the present invention. However, other lengths of panel-strap 100 may also be popular, depending upon local building construction codes, materials and contractor preferences.

Base 102 of panel-strap 100 extends from left-side end 110 to right-side end 110′ (when viewing strap 100 from its back-side surface 104). Ends 110 and 110′ are generally thin, flat, rectangular tabs, extending generally perpendicularly away from front-side surface 106 at the horizontal ends of base 102. Ends 110 and 110′ have several transverse through-holes 112 and 112′, respectively, for conveniently receiving nails or screws for securing panel-strap 100 to the inside surfaces of adjacent wall studs ((b.) and (b′.)—not shown here). Base front-side surface 106 also supports a plurality of prongs 108 extending generally perpendicularly out from it into the space between ends 110 and 110′ for being in the space between studs ((b.) and (b′.)—again, not shown here) when installed. Prongs 108 may have several effective shapes and sizes of gaps there-between for retaining various wires (a.) (also not shown here). Prongs 108 are shown here each with a distal notch on one side and a distal pointy tip on the other side. Other suitable shapes may include hooked or knobbed ends of the prongs, or angled, curved or curled inside prong surfaces. Also, spacing between the prongs may vary.

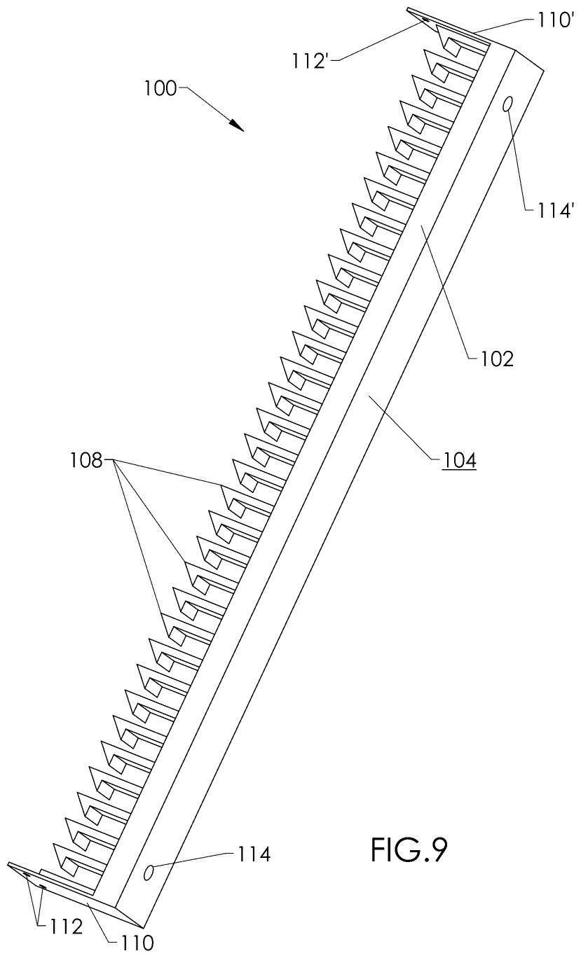

Prongs 108 may be made with uniform spacing between them, like, for example, about ½″ for wider spaces between prongs (e.g. at their proximal ends in FIGS. 8 and 9), and ⅛″ for narrower spaces (e.g. at their distal ends in FIGS. 8 and 9). Or, prongs 108 may be made with different spacing between them, like, for example, about 1″ for wider spaces and about ¼″ for narrower spaces, interspersed among individual prongs or prong sets of other narrower or wider spacing. This way, wires of different thickness, or gauge, may be conveniently accommodated and secured to the panel-strap of the present invention.

Also, the individual prongs 108 may be scored or creased near their proximal ends on base 102 to be conveniently selectively frangibly broken off, or snipped off with a trimmer tool, to enable custom modification of the prongs extending into space out from the base 102 to accommodate wires of different thickness or gauge.

FIG. 9 is a top, right-back perspective view of the embodiment of the panel-strap 100 according to the present invention as depicted in FIG. 8. In FIG. 9, back-side surface 104 of panel-strap 100 is depicted as having left and right through-holes 114 and 114′. These through-holes enable securement of the panel-strap 100 more directly to, for example, the inside wall of a building in the case where there are no adjacent studs according to an alternate embodiment of the present invention. In this case of more direct connection of panel-strap 100 to the inside wall of a building, it is preferable that a spacer be provided between the building inner wall surface 28 and panel-strap base back-side surface 104 when the connection is made. This way, the gap 24 between the panel-strap back-side surface 104 and the building wall's inside surface 28 (as depicted in FIG. 4 and discussed above) will be maintained to permit employment of the method according to the invention wherein the panel-straps 12 and 100 are maintained at a distance from the building inside wall to create a gap there-between to receive the electrician's fish-stick leading the additional/substitute wire for connection with the electrical panel/box 14 and the panel-straps 12, 100.

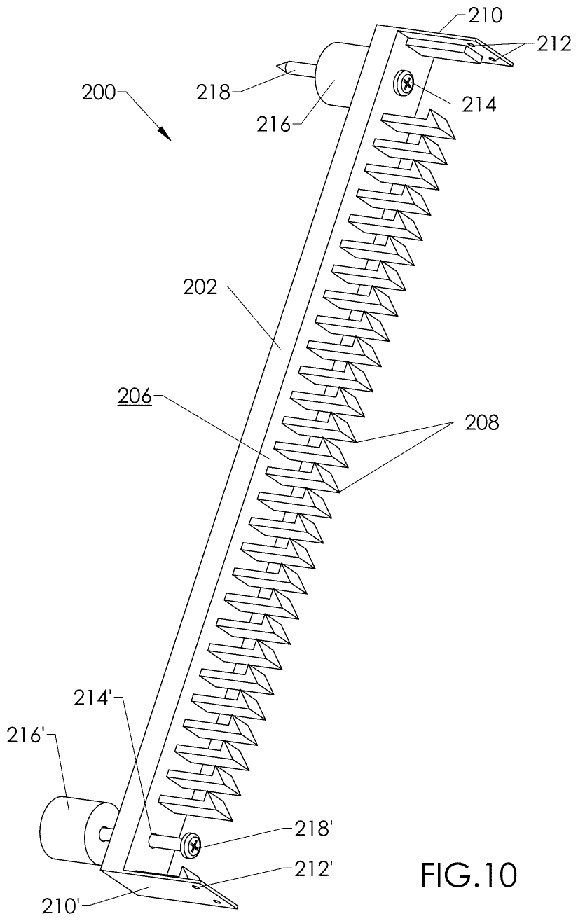

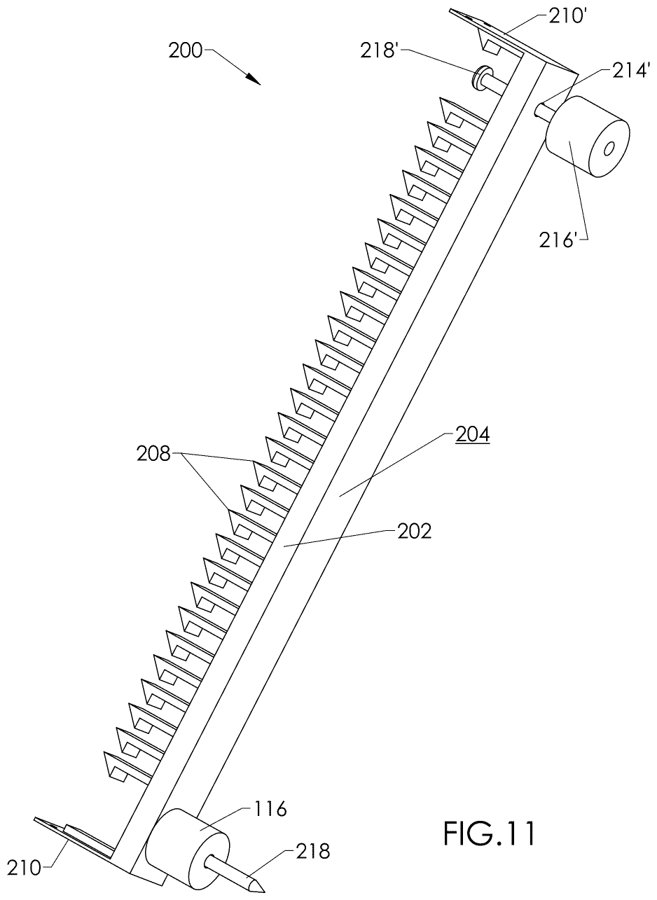

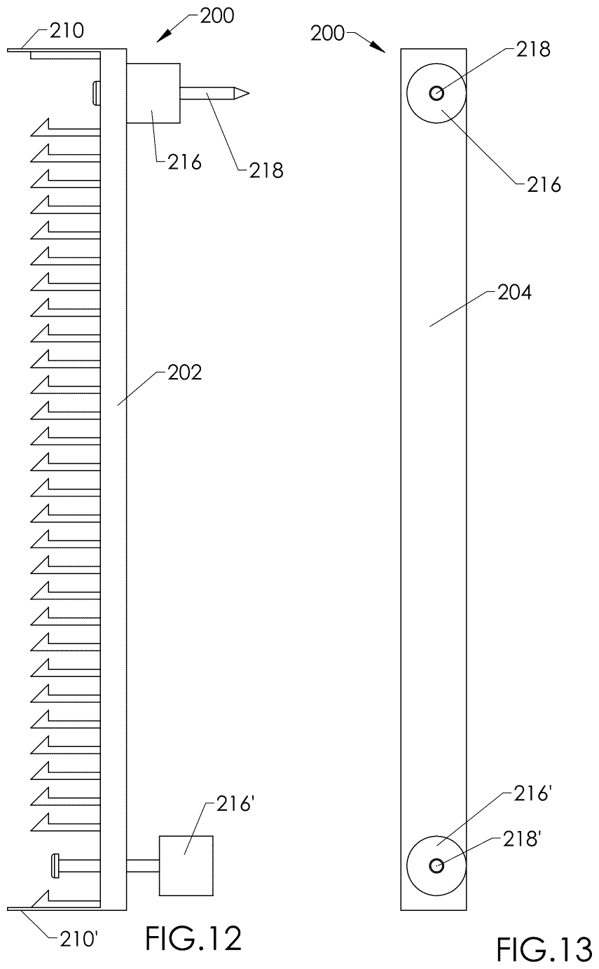

FIG. 10 is a top, right-front perspective view of an alternate “fastened-to-wall” embodiment 200 (versus the “fastened-between-studs” embodiment 100—discussed previously) of a panel-strap according to the present invention. Panel-strap 200 also has generally rectangular base 202 extending the length of the panel-strap. Generally, panel-strap 200 is sized to reasonably accommodate the width of an electrical junction panel or box nearby, possibly also fastened to an interior wall of a building. Therefore, panel-strap 200 may extend from about 1-3 feet between left-side end 210 and right-side end 210′ (when viewing strap 200 from its back-side surface 204). However, other lengths of panel-strap 200 may also be popular, depending upon the size and style of nearby electrical junction boxes, local building construction codes, materials and contractor preferences.

Ends 210 and 210′ are optional for panel-strap 200, but when they do exist, they are generally thin, flat rectangular tabs extending generally perpendicularly away from front-side surface 206 at both horizontal ends of base 202. Optional ends 210 and 210′ may have optional through-holes 212 and 212′, respectively, for conveniently receiving nails or screws for securing panel-strap 200 to, for example, the inside surfaces of adjacent wall studs if/when available.

Base 202 front-side surface 206 also supports a plurality of prongs 208, similar to the prongs 108 discussed above for panel-strap 100. Base 202 also has through-holes 214 and 214′ extending generally perpendicularly from base front surface 206 through to base back surface 204 near base 202's left ends 210 and 210′, respectively. Through-holes 214 and 214′ receive fasteners 218 and 218′ respectively, as do spacer-connectors 218 and 218′ on the back surface 204 of base 202. Spacer-connectors 218 and 218′ both have a length sufficient, when fasteners 218 and 218′ are inserted into or otherwise connected onto the building interior wall surface, to provide a gap of from about 0.5 inch to 2 inches between the interior wall surface and the back wall surface 204 of base 202 wide enough to permit passage therethrough of an electrician's “fish stick” towing an additional or substitute electrical line close to panel-strap 200.

Panel-straps 100, 200 may be manufactured by conventional techniques from metal, plastic or wood, for example, including combinations thereof. Prongs 108, 208 may alternatively be present as clamps, clips or snug through-holes in the same or near locations as discussed above regarding prongs.

Although this disclosed technology has been described above with reference to particular means, materials and embodiments, it is to be understood that the disclosed technology is not limited to these specifically disclosed particulars, but extends instead to all equivalents within the broad scope of this disclosure, drawings, and the following Claims.

1. In a method of building construction wherein an electrical junction box is provided near a building wall for receiving electrical wires for connection within said junction box, and a panel-strap is provided near the junction box for securing electrical wires to or from said junction box to said panel-strap, the improvement which comprises providing the panel-strap near, but spaced-apart from, the wall of the building so that a gap is provided between the panel-strap surface facing the wall and the wall surface facing the panel-strap, said gap being wide enough to permit the passage therethrough of an electrician's conventional fish stick for dragging an electrical line into proximity of the panel-strap.

2. The method of claim 1, wherein the gap between the panel strap and the wall is between about 0.5 inch and 2 inches.

3. The method of claim 1, wherein the panel strap is secured between adjacent wall studs.

4. The method claim 1 wherein the panel strap is secured to a building inside wall.

5. A panel-strap for securing electrical wires near an electrical junction box in a building, comprising:
an elongate base with top, bottom, front and back base surfaces, and two side ends, the base having also two tabular connectors, one connector being on each side end of the base;
the connectors both extending out away from the base's front surface;
the connectors both having a region for receiving a fastener generally parallel to the base's front surface, for securing the connectors and the panel-strap to studs in a wall in the building; and
the base also having a plurality of prongs with proximal ends and distal ends extending out away from the base's front surface, there being spaces between the distal ends of said prongs for receiving and securing electrical wires in spaces between said prongs.

6. The panel-strap of claim 5, wherein the spacing between prongs is regular.

7. The panel-strap of claim 5, wherein the spacing between prongs is irregular.

8. The panel-strap of claim 5, wherein individual prongs may be scored or creased to be selectively frangibly broken or trimmed off.

9. A panel-strap for securing electrical wires near an electrical junction box in a building, comprising:
an elongate base with top, bottom, front and back base surfaces, and two side ends, the base also having a plurality of spacer-connectors cooperating with said back base surface;
the spacer-connectors extending out away from the base's back surface;
each spacer-connector having a region for receiving a fastener generally perpendicular to the base's back surface for securing the panel-strap to a wall of the building, and each spacer-connector having a length generally parallel to said fastener, so that, when the panel-strap is installed, there is a gap between the facing wall surface and the panel-strap back wall surface, the width of the gap being sufficient to permit the passage there-through of an electrician's conventional fish stick for dragging an electrical line into proximity of the panel-strap; and
the base also having a plurality of clamps, clips, prongs or through-holes on the base's front surface for receiving and securing electrical wires to the panel-strap.

10. The panel-strap of claim 9 wherein the gap between the panel-strap and the wall is between is about 0.5 and 2 inches.
